(19) United States
(12) Patent Application Publication
(10) Pub. No.: US 2024/0424716 A1
(43) Pub. Date: Dec. 26, 2024

(54) MOLD AND PROCESS FOR MANUFACTURING BODY SUPPORT APPARATUSES, AND BODY SUPPORT APPARATUS

(71) Applicant: CHANGSHA ANXIANG MEDICAL TECHNOLOGY CO., LTD., CHANGSHA (CN)

(72) Inventor: JUNYUAN CHEN, CHANGSHA (CN)

(21) Appl. No.: 18/481,212

(22) Filed: Oct. 4, 2023

(30) Foreign Application Priority Data
Jun. 26, 2023 (CN) 202310759861.7

(51) Int. Cl. B29C 39/26; A47C 27/14

(52) U.S. Cl. CPC B29C 39/26; A47C 27/14

(57) ABSTRACT

A mold for manufacturing body support apparatuses includes: a first mold member, wherein a first accommodation chamber is defined in a surface of the first mold member; a second mold member, wherein the second mold member is disposed on a side, where the first accommodation chamber is defined, of the first mold member, the second mold member is a hollow structure, and an isolation layer in the body support apparatus is clamped between the second mold member and the first mold member, such that the first accommodation chamber is isolated from a second accommodation chamber enclosed by the second mold member, the second accommodation chamber being configured to allow injection of a memory foam fluid; and a third mold member, wherein the third mold member is disposed on a side, facing away from the first mold member, of the second mold member, and covers the second accommodation chamber.

### CROSS-REFERENCE TO RELATED APPLICATIONS

The present disclosure claims priority to Chinese Patent Application No. 202310759861.7, filed with the Chinese Patent Office on Jun. 26, 2023, titled “MOLD AND PROCESS FOR MANUFACTURING BODY SUPPORT APPARATUSES, AND BODY SUPPORT APPARATUS”, the entire contents of which are incorporated herein by reference.

### TECHNICAL FIELD

Embodiments of the present disclosure relate to the technical field of livingwares, and in particular, relate to a mold for manufacturing body support apparatuses, a process for manufacturing body support apparatuses, and a body support apparatus.

### BACKGROUND

In daily life, since seating furniture is generally hard, long-time sitting causes discomfort to human bodies. Accordingly, users generally place seat cushions on the seating furniture to improve sitting comfort.

A variety of seat cushions are available on the market. Most of the cushions are made of foam, and the foam deforms and fails to recover when it is pressed for a long time, resulting in decrease of comfort upon long-time use. On the contrast, seat cushions made of a memory foam better address the problem.

A memory foam seat cushion is generally composed of a gel material at the top and a memory foam at the bottom. In order to reliably isolate the gel material from the memory foam fluid during manufacturing, it is necessary to completely wrap, using a film, the bottom and the periphery of the memory foam fluid for foaming. Since the film is inevitably subject to wrinkles and other problems, the film may intrude into the surface of the periphery of the memory foam when the memory foam fluid is foamed, resulting in cracks on the surface of the memory foam upon foaming.

### SUMMARY

In view of the above problem, embodiments of the present disclosure provide a mold for manufacturing body support apparatuses, a process for manufacturing body support apparatuses, and a body support apparatus to solve the problem that cracks occur to the surface of a memory foam during manufacture of the body support apparatuses.

According to one aspect of the embodiments of the present disclosure, a mold for manufacturing body support apparatuses is provided. The mold includes: a first mold member, wherein a first accommodation chamber is defined in a surface of the first mold member, the first accommodation chamber being configured to accommodate a cushion layer of the body support apparatus; a second mold member, wherein the second mold member is disposed on a side, where the first accommodation chamber is defined, of the first mold member, the second mold member is a hollow structure, and an isolation layer in the body support apparatus is clamped between the second mold member and the first mold member, such that the first accommodation chamber is isolated from a second accommodation chamber enclosed by the second mold member, the second accommodation chamber being configured to allow injection of a memory foam fluid; and a third mold member, wherein the third mold member is disposed on a side, facing away from the first mold member, of the second mold member, and covers the second accommodation chamber to provide a foaming environment for the memory foam fluid in the second accommodation chamber.

According to another aspect of the embodiments of the present disclosure, a process for manufacturing body support apparatuses, applicable to the mold for manufacturing body support apparatuses according to the above aspect is provided. The process includes: placing a cushion layer and an isolation layer that are integrally formed into the first mold member, wherein an edge of the isolation layer stands out from an edge of the cushion layer, the cushion layer is disposed in the first accommodation chamber, and the isolation layer is disposed at a top of the first mold member; placing the second mold member on the first mold member, such that the isolation layer is clamped between the second mold member and the first mold member; injecting a prepared memory foam fluid into the second accommodation chamber; covering the third mold member on the second mold member; foaming the memory foam fluid in the mold; taking the body support apparatus out of the mold upon curing of the memory foam fluid; and cutting off the part, standing out from the edge of the cushion layer, of the isolation layer to obtain a finished body support apparatus.

According to still another aspect of the embodiments of the present disclosure, a body support apparatus is provided. The body support apparatus is manufactured by the process for manufacturing body support apparatuses according to the above aspect.

The above description only summarizes the technical solutions of the present disclosure. Specific embodiments of the present disclosure are described hereinafter to better and clearer understand the technical solutions of the present disclosure, to practice the technical solutions based on the disclosure of the specification and to make the above and other objectives, features and advantages of the present disclosure more apparent and understandable.

### BRIEF DESCRIPTION OF THE DRAWINGS

By reading the detailed description of preferred embodiments hereinafter, various other advantages and beneficial effects become clear and apparent for persons of ordinary skill in the art. The accompanying drawings are merely for illustrating the preferred embodiments, but shall not be construed as limiting the present disclosure. In all the accompanying drawings, like reference numerals denote like parts. In the drawings:

FIG. 1 is a schematic exploded structural view of a mold for manufacturing seat cushions taken from a top view angle according to an embodiment of the present disclosure;

FIG. 2 is a schematic structural view of a seat cushion according to an embodiment of the present disclosure;

FIG. 3 is a schematic exploded structural view of a mold for manufacturing seat cushions taken from a bottom view angle according to an embodiment of the present disclosure;

FIG. 4 is a schematic structural view of a mold for manufacturing seat cushions taken from a side view angle according to an embodiment of the present disclosure;

FIG. 5 is a schematic flowchart of a process for manufacturing seat cushions according to an embodiment of the present disclosure;

FIG. 6 is a schematic flowchart of sub-steps of step 370 in the process for manufacturing seat cushions according to an embodiment of the present disclosure; and

FIG. 7 is a schematic structural view of a seat cushion according to an embodiment of the present disclosure.

### REFERENCE NUMERALS IN THE EMBODIMENTS AND DENOTATIONS THEREOF

100—mold for manufacturing seat cushion; 110—first mold member; 111—first accommodation chamber; 112—flange; 120—second mold member; 121—second accommodation chamber; 130—third mold member; 131—third accommodation chamber; 140—handle;
200—seat cushion; 210—cushion layer; 220—isolation layer; 230—memory foam; 231—hole.

### DETAILED DESCRIPTION

The embodiments containing the technical solutions of the present disclosure are described in detail with reference to the accompanying drawings. The embodiments hereinafter are only used to clearly describe the technical solutions of the present disclosure. Therefore, these embodiments are only used as examples, but are not intended to limit the protection scope of the present disclosure.

Unless defined otherwise, all technical and scientific terms used herein have the same meaning as commonly understood by one of ordinary skill in the art to which this application pertains. The terms used herein in the specification of present disclosure are only intended to illustrate the specific embodiments of the present disclosure, instead of limiting the present disclosure. The terms “comprise.” “include,” and any variations thereof in the specification, claims, and the description of the drawings of the present disclosure are intended to cover a non-exclusive inclusion.

In the description of the present disclosure, the terms “first,” “second,” and the like are only used for distinguishing different objects, but shall not be understood as indication or implication of relative importance or implicit indication of the number of the specific technical features, the specific sequence or priorities. In the description of the embodiments of the present disclosure, the term “multiple” or “a plurality of” signifies at least two, unless otherwise specified.

The terms “example” and “embodiment” in this specification signify that the specific characteristic, structures or features described with reference to the embodiments may be covered in at least one embodiment of the present disclosure. This term, when appearing in various positions of the description, neither indicates the same embodiment, nor indicates an independent or optional embodiment that is exclusive of the other embodiments. A person skilled in the art would implicitly or explicitly understand that the embodiments described in this specification may be incorporated with other embodiments.

In the description of the embodiments of the present disclosure, the term “and/or” is merely an association relationship for describing associated objects, which represents that there may exist three types of relationships, for example, A and/or B may represent three situations: only A exists, both A and B exist, and only B exists. In addition, the forward-slash symbol “/” generally represents an “or” relationship between associated objects before and after the symbol.

In the description of the embodiments of the present disclosure, the term “multiple” or “a plurality of” signifies more than two (including two), unless otherwise specified. Likewise, the term “a plurality of groups” or “multiple groups” signifies more than two groups (including two groups), and the term “a plurality of pieces” or “multiple pieces” signifies more than two pieces (including two pieces).

In the description of the embodiments of the present disclosure, it should be understood that the terms “central,” “transversal.” “longitudinal.” “length,” “width,” “thickness,” “upper,” “lower,” “front,” “rear,” “left,” “right,” “vertical,” “horizontal,” “top,” “bottom,” “inner.” “outer,” “clockwise,” “counterclockwise,” “axial,” “radial,” “circumferential,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the embodiments of the present disclosure, it should be noted that unless otherwise specified and defined, the terms “mounted,” “coupled,” “connected,” “fixed,” and derivative forms thereof shall be understood in a broad sense, which, for example, may be understood as fixed connection, detachable connection or integral connection; may be understood as mechanical connection or electrical connection, or understood as direct connection, indirect connection via an intermediate medium, or communication between the interiors of two elements or interactions between two elements. Persons of ordinary skill in the art may understand the specific meanings of the above terms in the embodiments of the present disclosure according to the actual circumstances and contexts.

During manufacturing a memory foam seat cushion, a gel material and a thin film that are integrally formed need to be placed into an accommodation chamber of a lower mold. The gel material is in a lower layer, and the thin film is in an upper layer. To ensure that a memory foam fluid is absolutely isolated from the gel material, the thin film has a large area, and totally shields an inner wall of the accommodation chamber, such that the thin film itself forms a recess shape. Then, the memory foam fluid is injected into the recess formed by the thin film, and an upper mold is covered for foaming. Upon completion of foaming, an excessive part of the thin film is cut off to obtain the seat cushion. Since the thin film wrapped on the periphery of the memory foam is inevitably subject to wrinkles or other problems, during foaming, the thin film may intrude into the memory foam. As a result, cracks may occur to the periphery of the molded memory foam.

Based on this, the present disclosure provides a mold for manufacturing body support apparatuses. The mold employs a structure of three layers of mold members, such that during foaming of the memory foam, an edge of an isolation layer (for example, a thin film, a composite fabric, or the like) may be clamped between a first mold member and a second mold member. In addition, when the memory foam fluid is injected into the second mold member, it is ensured that the isolation layer completely isolates a cushion layer (for example, a gel material that is molded) from the memory foam fluid, and a periphery of the memory foam fluid is directly restricted by the second mold member, not wrapped by the isolation layer. In this way, a foam molded memory foam has smooth and tidy edges, and hence the finally manufactured body support apparatus has a good appearance. The body support apparatus may be a seat cushion, a lap pillow, a leg pillow, a lumbar pillow, a neck pillow, a pillow, or the like. Hereinafter description is giving using a seat cushion as an example. The molds and processes for manufacturing other types of body support apparatuses, and the body support apparatuses manufactured thereby are all similar to those of the seat cushions, and the seat cushions, with a difference only in appearance.

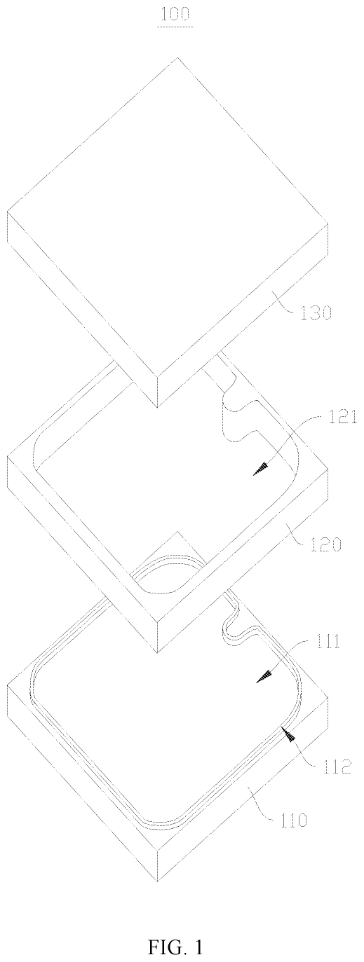

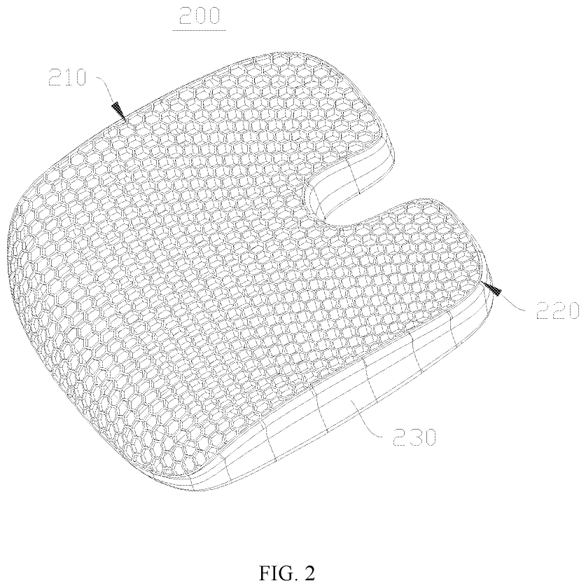

An embodiment of the present disclosure provides a mold for manufacturing seat cushions. Referring to FIG. 1 and FIG. 2, FIG. 1 illustrates a schematic exploded view of the mold for manufacturing seat cushions, and FIG. 2 illustrates a structure of a seat cushion. The mold 100 for manufacturing seat cushions includes a first mold member 110, a second mold member 120, and a third mold member 130. A first accommodation chamber 111 is defined in a surface of the first mold member 110. The first accommodation chamber 111 is configured to accommodate a cushion layer 210 of the seat cushion 200. The second mold member 120 is disposed on a side, where the first accommodation chamber 111 is defined, of the first mold member 110, the second mold member 120 is a hollow structure, an isolation layer 220 in the seat cushion 200 is clamped between the second mold member 120 and the first mold member 110, such that the first accommodation chamber 111 is isolated from a second accommodation chamber 121 enclosed by the second mold member 120, wherein the second accommodation chamber 121 is configured to allow injection of a memory foam fluid. The third mold member 130 is disposed on a side, facing away from the first mold member 110, of the second mold member 120, and covers the second accommodation chamber 121 to provide a foaming environment for the memory foam fluid in the second accommodation chamber 121.

A profile enclosed by the first accommodation chamber 111 and the second accommodation chamber 121 may be designed according to a shape desired by the seat cushion 200, such that a seat cushion having the corresponding shape is manufactured.

During manufacturing, the integrally formed cushion layer 210 and isolation layer 220 are placed in the first accommodation chamber 111. The cushion layer 210 faces downwards, the isolation layer 220 faces upwards, and an edge of the isolation layer 220 stands out from an edge of the cushion layer 210, such that the edge of the isolation layer 220 is lapped at a position where the first mold member 110 is located on an outer edge of the first accommodation chamber 111. Afterwards, the second mold member 120 is aligned with and placed on the first mold member 110, such that the isolation layer 220 lapped on the first mold member 110 is tightly clamped between the first mold member 110 and the second mold member 120, and the isolation layer 200 isolates the second accommodation chamber 121 inside the second mold member 120 from the first accommodation chamber 111 in the first mold member 110. Then the memory foam fluid is injected from top into the second accommodation chamber 121, the third mold member 130 is covered over the second mold member 120, and the memory foam fluid is foamed in the second accommodation chamber 121 to complete manufacture of the seat cushion.

In the mold 100 for manufacturing seat cushions according to the embodiments of the present disclosure, a structure of three layers of mold members, specifically, the first mold member 110, the second mold member 120, and the third mold member 130 that are successively laminated, is employed. By defining the first accommodation chamber 111 in the first mold member 110, an accommodation space is provided for the cushion layer 210. The edge of the isolation layer 220 is tightly clamped between the first mold member 110 and the second mold member 120, such that the first accommodation chamber 111 and the second accommodation chamber 121 are isolated from each other. In this way, while a reliable foaming environment is provided for the memory foam fluid, the memory foam fluid is prevented from entering the first accommodation chamber 111 and being bonded to the cushion layer 210. After the memory foam fluid is injected into the second accommodation chamber 121, the third mold member 130 is covered, and the memory foam fluid is then foamed. Since the edge of the memory foam fluid is restricted by an inner circumferential wall of the second accommodation chamber 121 and a smooth inner wall of the third mold member 130, it is ensured that a molded memory foam has tidy and smooth circumferential edges, and thus the manufactured seat cushion has a good appearance.

Still referring to FIG. 1, in some embodiments, a flange 112 is disposed on the surface of the first mold member 110. An inner space enclosed by the flange 112 forms the first accommodation chamber 111, and the isolation layer 220 is clamped between the second mold member 120 and a surface, facing away from the first mold member 110, of the flange 112.

By disposing the flange 112 on the first mold member 110, and forming the first accommodation chamber 111 by the inner space enclosed by the flange 112, since an area of a top surface of the flange 112 is small, during the manufacture, flatness of the surface is better ensured. In this way, when the isolation layer 220 is clamped between the second mold member 120 and the surface, facing away from the first mold 110, of the flange 112, the circumferential edges of the isolation layer 220 are tightly and reliably clamped, such that no slit is present in the periphery of the isolation layer 220 and the memory foam fluid is prevented from leaking from any possible slit.

The isolation layer 220 is preferentially made of a composite fabric or other textiles having a specific thickness, such that it is further ensured that the periphery of the isolation layer 220 is tightly clamped to achieve sealing.

It may be understood that in some other embodiments, a recess may be defined in a top surface of the first mold member 110. An inner space of the recess forms the first accommodation chamber 111.

For flatness and good appearance of the manufactured seat cushion, in some embodiments, as illustrated in FIG. 1, a profile of an edge of the first accommodation chamber 111 is consistent with a profile of an edge of the second accommodation chamber 121.

By defining the profile of the edge of the first accommodation chamber 111 to be consistent with the profile of the edge of the second accommodation chamber 121, it is ensured that the finally foam molded seat cushion 200 has a flat surface, as illustrated in FIG. 2. That is, the cushion layer 210 and a memory foam 230 are consistent in dimensions along a circumferential direction. In this way, there is no need to cut the edge of the cushion layer 210 or the memory foam 230, such that the efficiency in manufacturing the seat cushion 200 is improved.

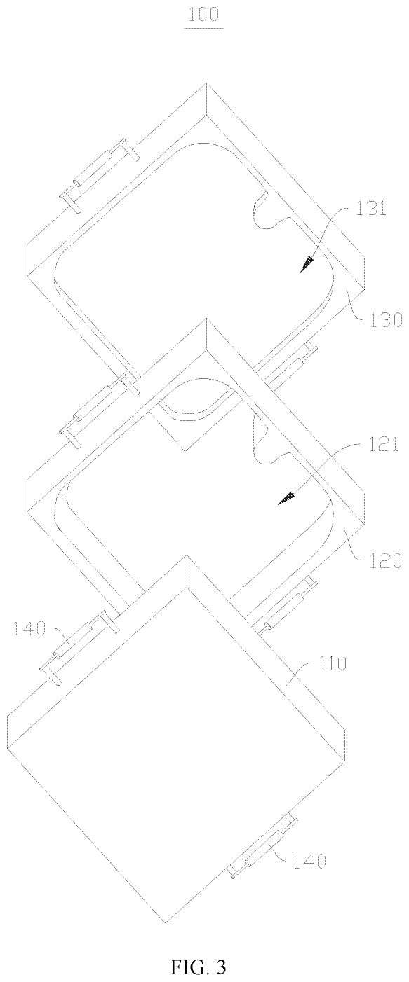

To provide a sufficient foaming space for the memory foam, the present disclosure provides another example. FIG. 3 illustrates a schematic exploded structural view of a mold for manufacturing seat cushions taken from a bottom view angle according to an embodiment of the present disclosure. As illustrated in FIG. 3, a recess is defined in a surface, facing towards the second mold member 120, of the third mold member 130. A third accommodation chamber 131 is defined in the recess. The third accommodation chamber 131 is configured to provide an expansion space for the memory foam fluid when the memory foam fluid is foamed in the second accommodation chamber 121.

The volume increases when the memory foam fluid is foamed. With the increase of the thickness, to prevent an increase of costs of the mold due to too large thickness of the second mold member 120, in this embodiment, the recess is defined in a bottom surface of the third mold member 130. The third accommodation chamber 131 defined in the recess is communicated with the second accommodation chamber 121 when the third mold member 130 is covered on the second mold member 120, such that during foaming of the memory foam fluid in the second accommodation chamber 121, the thickness of the memory foam fluid increases and the memory foam fluid extends into the third accommodation chamber 131 which also provides an expansion space for the molded memory foam fluid. This ensures that a seat cushion with desired dimensions is eventually manufactured. In addition, since the edge of the memory foam fluid is restricted by smooth inner walls of the second accommodation chamber 121 and the third accommodation chamber 131, it is further ensured that the foam molded memory foam has an entirely smooth and tidy surface, and the manufactured seat cushion has a good appearance.

It should be noted that the memory foam fluid expands during foaming, and the finally molded shape is subject to the external structure. Where the periphery of the memory foam is uneven, the molded memory foam has an uneven peripheral structure.

Accordingly, for flatness of the circumferential edges of the memory foam, in some embodiments, the profile of the edge of the third accommodation chamber 131 is consistent with the profile of the edge of the second accommodation chamber 121.

By defining the profile of the edge of the third accommodation chamber 131 to be consistent with the profile of the edge of the second accommodation chamber 121, it is ensured that no volume change occurs to the memory foam when expanding to a boundary between the second accommodation chamber 121 and the third accommodation chamber 131 during foaming, and thus the periphery of the finally molded memory foam is smooth and flat and the manufactured seat cushion has a tidy and good appearance.

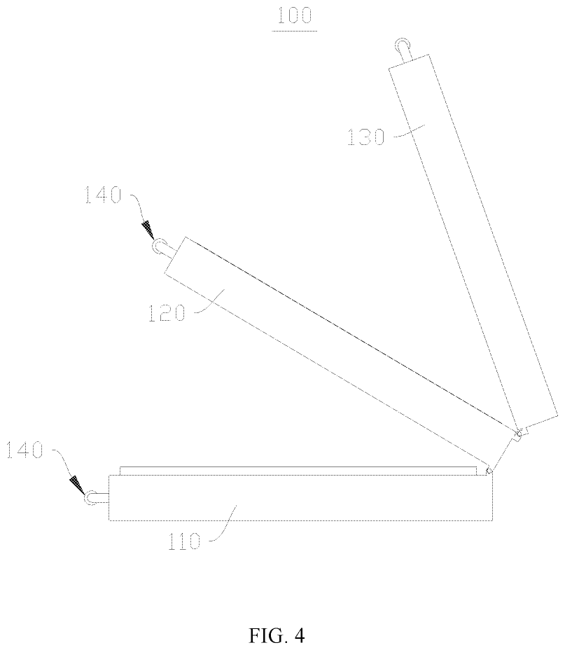

Since the mold is heavy, for ease of operations, the present disclosure further provides another example. FIG. 4 illustrates a structure of the mold for manufacturing seat cushions. As illustrated in FIG. 4, two facing surfaces of the first mold member 110 and the second mold member 120 are rotatably connected at the edges thereof, and two facing surfaces of the second mold member 120 and the third mold members 130 are rotatably connected at the edges thereof.

By rotatably connecting the first mold member 110, the second mold member 120, and the third mold member 130, when the mold members are opened or closed, these mold members do not need to be completely taken off, but only need to be opened at a fixed angle. Therefore, the operation is convenient and labor saving.

For ease of taking the mold, the present disclosure further provides another example. Still referring to FIG. 3, a handle 140 is disposed on a side surface of at least one of the first mold member 110, the second mold member 120, and the third mold member 130 along a circumferential direction.

With respect to split arrangement of the mold members in FIG. 3, handles 140 may be disposed on both sides of each of the mold members. In this way, it is convenient for the technician to manually lift up or place down the mold 100 for manufacturing seat cushions. With respect to rotatable connections between the mold members in FIG. 4, the handle 140 may be disposed only on a front side of each of the mold members. In this way, it is convenient for the technician to rotatably lift up the mold members via the handles 140.

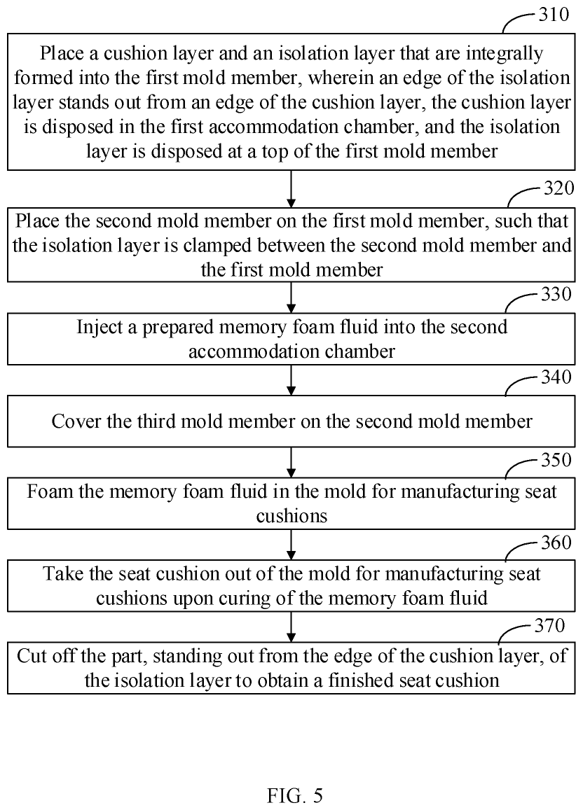

An embodiment of the present disclosure further provides a process for manufacturing seat cushions, which employs the mold 100 for manufacturing seat cushions according to any of the above embodiments. FIG. 5 illustrates a flowchart of a process for manufacturing seat cushions. As illustrated in FIG. 5, the process includes the following steps.

In step 310, a cushion layer and an isolation layer that are integrally formed are placed into the first mold member, wherein an edge of the isolation layer stands out from an edge of the cushion layer, the cushion layer is disposed in the first accommodation chamber, and the isolation layer is disposed at a top of the first mold member.

In this step, the cushion layer may be made of a composite fabric, the isolation layer may be made of a gel material, and the cushion layer and the isolation layer are integrally molded and prepared in advance. Specifically, the gel material is first foamed in the composite fabric, and hence a gel cushion layer with one surface having the composite fabric is formed.

In step 320, the second mold member is placed on the first mold member, such that the isolation layer is clamped between the second mold member and the first mold member.

In this step, since the edge of the isolation layer stands out from the edge of the cushion layer, after the cushion layer is disposed at a bottom of the first accommodation chamber, the isolation layer may cover an opening of the first accommodation chamber, and hence, after the second mold member is placed on the first mold member, the isolation layer may be tightly clamped between the first mold member and the second mold member.

In step 330, a prepared memory foam fluid is injected into the second accommodation chamber.

In this step, since the isolation layer is tightly clamped between the first mold member and the second mold member, it is not only ensured that the second accommodation chamber is isolated from the first accommodation chamber, but also ensured that no composite fabric is present in the second accommodation chamber, such that the memory foam fluid injected into the second accommodation chamber is in direct contact with an inner wall of the second accommodation chamber.

A formulated memory foam fluid includes: a polyurethane raw material, a blowing agent (typically water, or some chemical blowing agents such as HFC, CFC, or the like), a catalyst, a crosslinking agent, a filler, a flame retardant, and the like. The ratio and weight of the raw material, and the precision of ingredients are all significant to performance of the final prepared memory foam. Under a specific temperature, the catalyst may accelerate the foaming reaction. During formulation of the memory foam fluid, these materials need to be stirred at a constant speed and a specific duration, to achieve a better foaming effect.

In step 340, the third mold member is covered on the second mold member.

In step 350, the memory foam fluid is foamed in the mold for manufacturing seat cushions.

In this step, since the memory foam fluid injected into the second accommodation chamber is in direct contact with the inner wall of the second accommodation chamber, the periphery of the memory foam fluid may not be intruded by other substances during foaming, and thus the periphery of the molded memory foam is smooth and tidy.

During foaming in the mold, the volume of the memory foam fluid increases to form a foam body with micropores. During foaming, the temperature and pressure need to be better controlled to achieve a better foaming effect and maintain performance of the memory foam. Chemical bonds are formed between molecules of the raw material upon foaming, such that the molecules of the raw material are mechanically bonded to each other. In this way, elasticity and memory of the entire foam are improved. The amount, type, and addition timing of the crosslinking agent are significant to the final performance of the molded memory foam.

In step 360, the seat cushion is taken out of the mold for manufacturing seat cushions upon curing of the memory foam fluid.

It takes some time for the foam body upon crosslinking to cure. Upon curing, the mechanical strength, stability, and dimensions of the foam body are not affected. In the curing process, the temperature, humidity, and other environmental factors need to be taken into consideration, to prevent the foam from shrinkage and deformation during curing.

In step 370, the part, standing out from the edge of the cushion layer, of the isolation layer is cut off to obtain a finished seat cushion.

After the memory foam body is finally molded upon curing, the undesired part of the isolation layer is cut off to obtain the finished seat cushion which is smooth and tidy in the periphery and has a good appearance.

In the process for manufacturing seat cushions according to the embodiments of the present disclosure, by using the mold for manufacturing seat cushions according to the above embodiment, the isolation layer is tightly clamped between the first mold member and the second mold member, such that the memory foam fluid and the cushion layer are isolated from each other, and the second accommodation chamber which receives the memory foam fluid has a smooth surface. In this way, during foaming, the periphery of the memory foam fluid may not be intruded by other substances, and thus the finally molded memory foam has a smooth and tidy surface and the manufactured seat cushion has a good appearance.

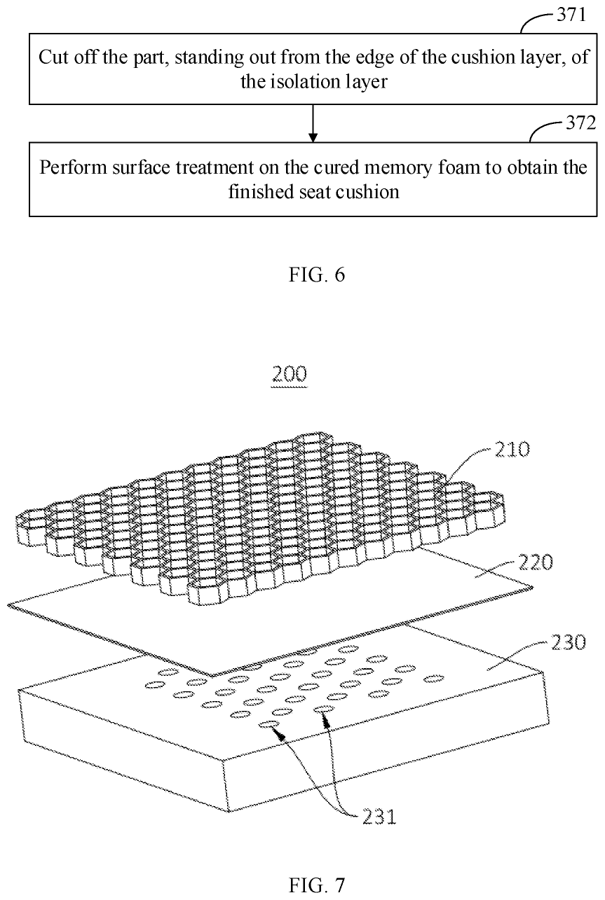

For further improvement of the appearance of the manufactured seat cushion, the present disclosure further provides an example. Specifically, referring to FIG. 6, a flowchart of substeps of step 370 is illustrated. As illustrated in FIG. 6, step 370 includes the following steps.

In step 371, the part, standing out from the edge of the cushion layer, of the isolation layer is cut off.

In step 372, surface treatment is performed on the cured memory foam to obtain the finished seat cushion.

The surface treatment on the cured memory foam includes trimming and skin-covering. Upon the surface treatment, the manufactured seat cushion is better in appearance.

For better air permeability of the seat cushion, in some embodiments, step 372 includes the following substeps.

In substep 3721, the seat cushion is placed as making the memory foam face upwards.

In substep 3722, a punching stop device is placed on the memory foam according to punching positions on the memory foam, wherein the punching stop device includes a plurality of tubular posts, heights of the tubular posts matching a height of the memory foam. Matching of the heights means the heights are equal or approximately equal.

In substep 3723, a downward force is applied to the punching stop device along a vertical direction using a press machine, until the tubular posts of the punching stop device stop in response to penetrating through the memory foam, such that the tubular posts cut off a part of the memory foam matching a shape of the tubular posts.

In substep 3724, the cut memory foam is taken out to obtain the finished seat cushion.

After the cut memory foam is taken out, holes corresponding to the tubular posts are formed in the memory foam. The holes run through then entire memory foam, such that the seat cushion has a better air permeability. FIG. 7 illustrates an exploded view of a manufactured seat cushion. As illustrated in FIG. 7, a plurality of holes 231 are opened in the memory foam 230.

The punching stop device and the press machine are conventional apparatuses, the structures of which are not described in detail herein. The tubular posts of the punching stop device are made of a metal material, such that a cutting function is provided. The number of tubular posts is not limited. The tubular posts are uniformly arranged, such that the holes are well organized in the final memory foam, and the entire structure of the seat cushion is uniform and is subjected to uniform forces. An embodiment of the present disclosure further provides a seat cushion. Specifically, still referring to FIG. 2, a structure of a seat cushion 200 is illustrated. The seat cushion 200 is manufactured by the process for manufacturing seat cushions according to any of the above embodiments. In the seat cushion according to the embodiments of the present disclosure, the molded memory foam has a smooth and tidy surface, and the seat cushion has a simple and beautiful appearance.

It should be finally noted that the above-described embodiments are merely for illustration of the present disclosure, but are not intended to limit the present disclosure. Although the present disclosure is described in detail with reference to these embodiments, a person skilled in the art may also make various modifications to the technical solutions disclosed in the embodiments, or make equivalent replacements to a part of or all technical features contained therein. Such modifications or replacement, made without departing from the principles of the present disclosure, shall fall within the scope of the present disclosure. Especially, various technical features mentioned in various embodiments may be combined in any fashion as long as there is no structural conflict.

What is claimed is:

1. A mold for manufacturing body support apparatus, comprising:
a first mold member, wherein a first accommodation chamber is defined in a surface of the first mold member, the first accommodation chamber being configured to accommodate a cushion layer of the body support apparatus;
a second mold member, wherein the second mold member is disposed on a side, where the first accommodation chamber is defined, of the first mold member, the second mold member is a hollow structure, and an isolation layer in the body support apparatus is clamped between the second mold member and the first mold member, such that the first accommodation chamber is isolated from a second accommodation chamber enclosed by the second mold member, the second accommodation chamber being configured to allow injection of a memory foam fluid; and
a third mold member, wherein the third mold member is disposed on a side, facing away from the first mold member, of the second mold member, and covers the second accommodation chamber to provide a foaming environment for the memory foam fluid in the second accommodation chamber.

2. The mold according to claim 1, wherein a flange is disposed on the surface of the first mold member, wherein an inner space enclosed by the flange forms the first accommodation chamber, and the isolation layer is clamped between the second mold member and a surface, facing away from the first mold member, of the flange.

3. The mold according to claim 1, wherein a profile of an edge of the first accommodation chamber is consistent with a profile of an edge of the second accommodation chamber.

4. The mold according to claim 1, wherein a recess is defined in a surface, facing towards the second mold member, of the third mold member, wherein a third accommodation chamber is defined in the recess, the third accommodation chamber being configured to provide an expansion space for the memory foam fluid when the memory foam fluid is foamed in the second accommodation chamber.

5. The mold according to claim 4, wherein a profile of an edge of the third accommodation chamber is consistent with a profile of an edge of the second accommodation chamber.

6. The mold according to claim 1, wherein two facing surfaces of the first mold member and the second mold member are rotatably connected to each other at edges thereof, and two facing surfaces of the second mold member and the third mold member are rotatably connected at an edge thereof.

7. The mold according to claim 1, wherein a handle is disposed on a side surface of at least one of the first mold member, the second mold member, and the third mold member along a circumferential direction.

8. The mold according to claim 1, wherein a recess is defined in a top surface of the first mold member, wherein an inner space of the recess forms the first accommodation chamber.

9. A process for manufacturing body support apparatus, applicable to the mold for manufacturing body support apparatus as defined in claim 1, the process comprising:
placing a cushion layer and an isolation layer that are integrally formed into the first mold member, wherein an edge of the isolation layer stands out from an edge of the cushion layer, the cushion layer is disposed in the first accommodation chamber, and the isolation layer is disposed at a top of the first mold member;
placing the second mold member on the first mold member, such that the isolation layer is clamped between the second mold member and the first mold member;
injecting a prepared memory foam fluid into the second accommodation chamber;
covering the third mold member on the second mold member;
foaming the memory foam fluid in the mold;
taking the body support apparatus out of the mold upon curing of the memory foam fluid; and
cutting off the part, standing out from the edge of the cushion layer, of the isolation layer to obtain a finished body support apparatus.

10. The process according to claim 9, wherein cutting off the part, standing out from the edge of the cushion layer, of the isolation layer to obtain the finished body support apparatus comprises:
cutting off the part, standing out from the edge of the cushion layer, of the isolation layer; and
performing surface treatment on the cured memory foam to obtain the finished body support apparatus.

11. The process according to claim 10, wherein performing surface treatment on the cured memory foam to obtain the finished body support apparatus comprises:
placing the body support apparatus as making the memory foam face upwards;
placing a punching stop device on the memory foam according to punching positions on the memory foam, wherein the punching stop device comprises a plurality of tubular posts, heights of the tubular posts matching a height of the memory foam;
applying a downward force to the punching stop device along a vertical direction using a press machine, until the tubular posts of the punching stop device stop in response to penetrating through the memory foam, such that the tubular posts cut off a part of the memory foam matching a shape of the tubular posts; and
taking out of the cut memory foam to obtain the finished body support apparatus.

12. The process according to claim 9, wherein the cushion layer is made from a composite fabric, and the isolation layer is made from a gel material; and
prior to placing the cushion layer and the isolation layer that are integrally formed into the first mold member, the method further comprises:
forming a gel cushion layer with one surface having the composite fabric by foaming the gel material on the composite fabric, the gel cushion layer with one surface having the composite fabric being the cushion layer and the isolation layer that are integrally formed.

13. The process according to claim 9, wherein the edge of the isolation layer standing out from the edge of the cushion layer, such that the edge of the isolation layer is lapped at a position where the first mold member is located on an outer edge of the first accommodation chamber.

14. The process according to claim 9, wherein the memory foam fluid comprises a polyurethane raw material, a blowing agent, a catalyst, a crosslinking agent, a filler, and a flame retardant.

15. The process according to claim 14, wherein the blowing agent is water, HFC, or CFC.

16. The process according to claim 10, wherein performing surface treatment on the cured memory foam comprises trimming and skin-covering.

17. The process according to claim 9, wherein a flange is disposed on the surface of the first mold member of the mold for manufacturing body support apparatus, wherein an inner space enclosed by the flange forms the first accommodation chamber, and the isolation layer is clamped between the second mold member and a surface, facing away from the first mold member, of the flange.

18. The process according to claim 9, wherein in the mold for manufacturing body support apparatus, a profile of an edge of the first accommodation chamber is consistent with a profile of an edge of the second accommodation chamber.

19. The process according to claim 9, wherein in the mold for manufacturing body support apparatus, a recess is defined in a surface, facing towards the second mold member, of the third mold member, wherein a third accommodation chamber is defined in the recess, the third accommodation chamber being configured to provide an expansion space for the memory foam fluid when the memory foam fluid is foamed in the second accommodation chamber.

20. A body support apparatus, produced by the process for manufacturing body support apparatus as defined in claim 9.
